(19) United States
(12) Patent Application Publication
(10) Pub. No.: US 2015/0178577 A1
(43) Pub. Date: Jun. 25, 2015

(54) IMAGE PROCESSING APPARATUS, AND IMAGE PROCESSING METHOD

(71) Applicant: FUJITSU LIMITED, Kawasaki-shi (JP)

(72) Inventors: Kozo Baba, Oita (JP); Norio HASHIGUCHI, Yokohama (JP); Kunikazu Takahashi, Kawasaki (JP)

(21) Appl. No.: 14/615,526

(22) Filed: Feb. 6, 2015

Related U.S. Application Data
(63) Continuation of application No. PCT/JP2012/072196, filed on Aug. 31, 2012.

(51) Int. Cl. G06K 9/00; G06K 9/46

(52) U.S. Cl. CPC G06K 9/00805; G06K 9/4661

(57) ABSTRACT

An image processing apparatus according to an embodiment has an identification unit, a detection unit, and a determination unit. The image processing apparatus according to the embodiment identifies moving image data taken by a camera in the night-time and detects a high-brightness region from frames of the identified moving image data. The image processing apparatus determines whether or not the high-brightness region is a subject to be detected, in a switchable manner depending on whether the moving image data has been taken during curve running or straight running.

### CROSS-REFERENCE TO RELATED APPLICATION(S)

This application is a continuation of International Application No. PCT/JP2012/072196, filed on Aug. 31, 2012, the entire contents of which are incorporated herein by reference.

### FIELD

The embodiments discussed herein are related to an image processing apparatus and an image processing method.

### BACKGROUND

Car accidents could be prevented to some extent by providing a driver with information on places where there are likely to occur near-accidents, that is, incidents giving the driver a fright such as a near-miss with a traverser. To identify the information on places where near-accidents are likely to occur, data recorded in an event data recorder can be used. For example, the event data recorder records the location of a vehicle, the date and time of shooting, the acceleration of the vehicle, the speed of the vehicle, moving images of sight ahead of the vehicle, and others.

If an attempt is made to detect a near-accident only based on such numerical data as the acceleration of the vehicle recorded in the event data recorder, events not actually being near-accidents may be wrongly detected. This is because the acceleration of the running vehicle may sharply change, regardless of near-accidents, due to undulations of the road or the like.

To prevent false detections of near-accidents as described above, there is an idea to analyze the moving images of sight ahead of the vehicle recorded in the event data recorder together with the acceleration for detection of near-accidents.

Possible causes of near-accidents include the presence of subjects to be detected such as traversers and bicycles in the lane where the vehicle is running. In particular, near-accidents are likely to occur in the night-time due to poor visibility. Accordingly, by determining whether there is any subject to be detected from the image shot in the night-time, it is possible to determine whether the cause of a near-accident exists in the image and also conclude whether a near-accident has occurred.

The camera used in the event data recorder is a visible-light camera. The image shot by the visible-light camera in the night-time is greatly affected by the headlights of the vehicle. For example, when any subject to be detected exists ahead of the vehicle and is illuminated by the headlights of the vehicle, a large amount of light is reflected from the subject. Therefore, according to the conventional technique, it is possible to identify a high-brightness region in the image shot in the night-time as a subject to be detected.

Patent Literature 1: Japanese Laid-open Patent Publication No. 2010-205087.

However, the foregoing conventional technique has a problem in that it is not possible to correctly detect a subject to be detected.

For example, the vehicle may go round a curve in the road with a telephone pole, an automatic vending machine, or the like. When illuminated by the headlights of the vehicle, the telephone pole or the automatic vending machine not being a subject to be detected, reflects a large amount of light and thus appears a high-brightness region in the image. Therefore, it is difficult to discriminate a real subject to be detected from a high-brightness region not being a subject to be detected.

### SUMMARY

According to an aspect of an embodiment, an image processing apparatus includes a memory; and a processor coupled to the memory, wherein the processor executes a process including identifying moving image data taken by a camera in the night-time; detecting a high-brightness region from frames of the moving image data; and determining whether or not the high-brightness region is a subject to be detected, in a switchable manner depending on whether the moving image data has been taken during curve running or straight running.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a configuration of an image processing apparatus according to a first embodiment;

FIG. 2 is a functional block diagram of a configuration of an image processing apparatus according to a second embodiment;

FIG. 3 is a diagram illustrating one example of a data structure of event data recorder information;

FIG. 4 is a diagram illustrating one example of a predetermined region as a subject to be detected by a night-time determination unit;

FIG. 5 is a diagram (1) for describing a process executed by a detection unit;

FIG. 6 is a diagram (2) for describing a process executed by the detection unit;

FIG. 7 is a diagram for describing one example of a process executed by a determination unit;

FIG. 8 is a diagram illustrating a relationship in distance between a camera and a high-brightness region with changes in the distance at a constant rate;

FIG. 9 is a diagram illustrating a relationship in distance between the camera and the high-brightness region without changes in the distance at a constant rate;

FIG. 10 is a diagram for describing a process for calculating the distance between the high-brightness region and the camera;

FIG. 11 is a flowchart of a process executed by the image processing apparatus according to the second embodiment; and

FIG. 12 is a diagram illustrating one example of a computer to execute an image processing program.

### DESCRIPTION OF EMBODIMENTS

However, the foregoing conventional technique has a problem in that it is not possible to correctly detect a subject to be detected.

For example, the vehicle may go round a curve in the road with a telephone pole, an automatic vending machine, or the like. When illuminated by the headlights of the vehicle, the telephone pole or the automatic vending machine not being a subject to be detected, reflects a large amount of light and thus appears a high-brightness region in the image. Therefore, it is difficult to discriminate a real subject to be detected from a high-brightness region not being a subject to be detected.

Preferred embodiments of the present invention will be explained with reference to accompanying drawings. The present invention is not limited by the embodiments.

### [a] First Embodiment

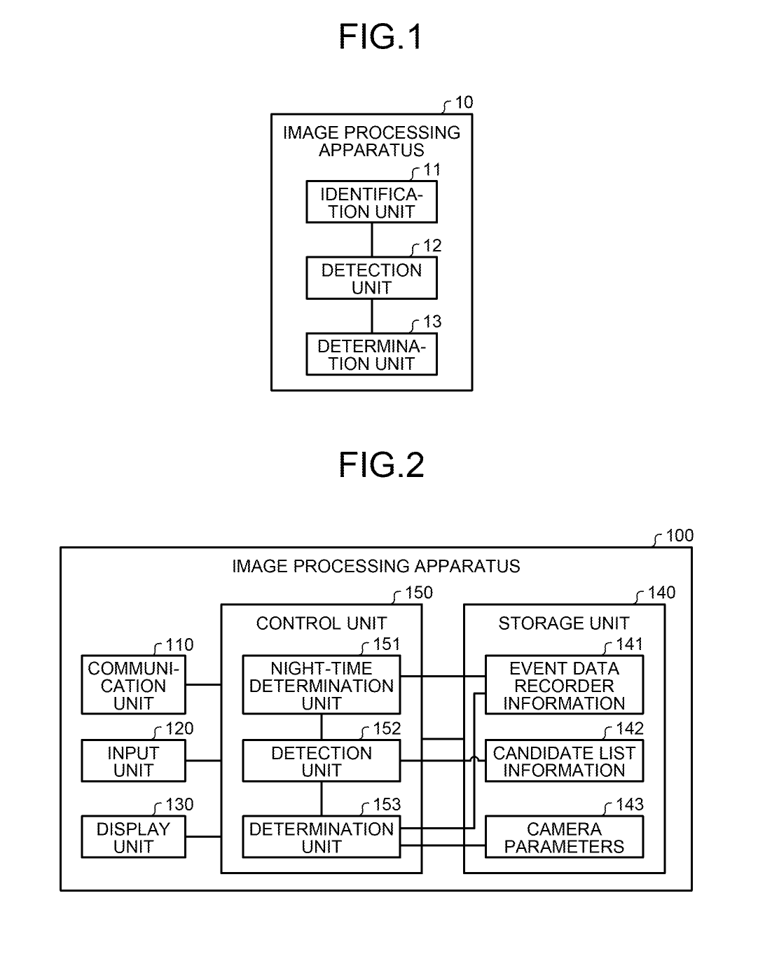

Configuration of the image processing apparatus according to the first embodiment will be described. FIG. 1 is a functional block diagram of a configuration of the image processing apparatus according to the first embodiment. As illustrated in FIG. 1, an image processing apparatus 10 has an identification unit 11, a detection unit 12, and a determination unit 13.

The identification unit 11 identifies moving image data taken by a camera in the night-time.

The detection unit 12 detects a high-brightness region from frames of the moving image data identified by the identification unit 11.

The determination unit 13 determines whether or not the high-brightness region is a subject to be detected, in a switchable manner depending on whether the moving image data has been taken during curve running or straight running of the vehicle.

Operations of the image processing apparatus 10 according to the first embodiment will be described. The image processing apparatus 10 identifies moving image data taken by a camera in the night-time and detects a high-brightness region from frames of the identified image data. The image processing apparatus 10 determines whether or not the high-brightness region is a subject to be detected, in a switchable manner depending on whether the moving image data has been taken during curve running or straight running of the vehicle. For example, if the lane in which the vehicle is running is set as a detection region, a stationary object in the detection region is wrongly detected as a high-brightness region during curve running. Meanwhile, when the vehicle is running in straight, no stationary object is detected in the detection region. Accordingly, by determining whether or not the high-brightness region is a subject to be detected in a switchable manner depending on whether the vehicle is curve-running or straight-running, it is possible to make determinations according to the both situations and correctly detect a subject to be detected.

### [b] Second Embodiment

Configuration of an image processing apparatus according to the second embodiment will be described. FIG. 2 is a functional block diagram of a configuration of the image processing apparatus according to the second embodiment. As illustrated in FIG. 2, an image processing apparatus 100 has a communication unit 110, an input unit 120, a display unit 130, a storage unit 140, and a control unit 150.

The communication unit 110 is a processing unit that executes data communications with outer devices via a network. For example, the communication unit 110 is equivalent to a communication device or the like.

The input unit 120 is an input device that inputs various data to the image processing apparatus 100. For example, the input unit 120 is equivalent to a keyboard, a mouse, a touch panel, or the like. The display unit 130 is a display device that displays data output from the control unit 150. For example, the display unit 130 is equivalent to a liquid crystal display, a touch panel, or the like.

The storage unit 140 stores event data recorder information 141, candidate list information 142, and camera parameters 143. For example, the storage unit 140 is equivalent to a semiconductor memory device such as a random access memory (RAM), a read only memory (ROM), a flash memory, or the like.

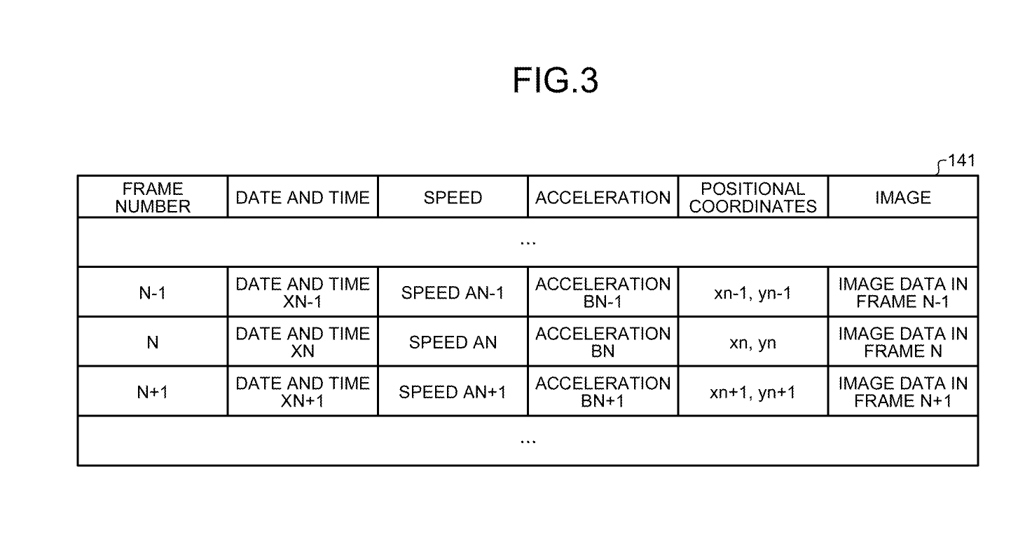

The event data recorder information 141 includes various data recorded in an event data recorder. FIG. 3 is a diagram illustrating one example of a data structure of event data recorder information. As illustrated in FIG. 3, the event data recorder information 141 stores frame numbers, dates and times, speeds, accelerations, positional coordinates, and images in association with one another. The frame number refers to a number for uniquely identifying a frame. The date and time refers to the date and time when the corresponding frame was taken. The speed refers to the speed of a vehicle equipped with the event data recorder at the time of taking the corresponding frame. The acceleration refers to the acceleration of the vehicle equipped with the event data recorder at the time of taking the corresponding frame. The positional coordinates refer to the positional coordinates of the vehicle equipped with the event data recorder at the time of taking the corresponding frame. The image refers to image data of the corresponding frame.

The candidate list information 142 refers to a list of frames including a high-brightness region out of process frames taken in the night-time. The candidate list information 142 will be described later in detail.

The camera parameters 143 refer to camera parameters used in the event data recorder. The camera parameters 143 will be described later in detail.

The control unit 150 has a night-time determination unit 151, a detection unit 152, and a determination unit 153. The control unit 150 is equivalent to an integrated device such as an application specific integrated circuit (ASIC) or a field programmable gate array (FPGA). The control unit 150 is also equivalent to an electronic circuit such as a CPU or a micro processing unit (MPU).

The night-time determination unit 151 refers to the event data recorder information 141 to extract each image data corresponding to the frame number of a frame taken in the night-time. In the following description, each image data corresponding to the frame number of the frame taken in the night-time will be referred to as a process frame. The night-time determination unit 151 outputs information of each extracted process frame to the detection unit 152. The information of the process frame is associated with the frame number of the applicable process frame and the like.

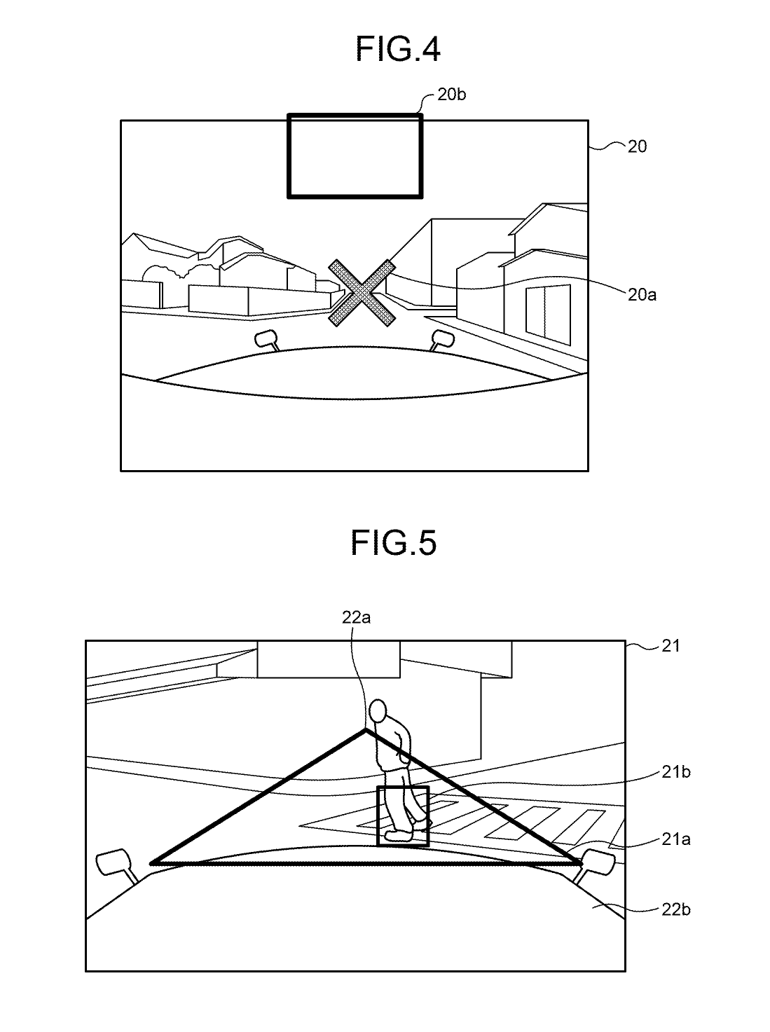

Descriptions will be given as to one example of a process for identifying a process frame taken in the night-time by the night-time determination unit 151. The night-time determination unit 151 calculates an average brightness in a predetermined region of the image data. FIG. 4 is a diagram illustrating one example of a predetermined region as a subject to be detected by the night-time determination unit. For example, the night-time determination unit 151 set a region 20b above a vanishing point 20a in image data 20.

The night-time determination unit 151 may identify the vanishing point 20a in any manner. For example, the night-time determination unit 151 subjects the image data 20 to Hough transformation to detect a plurality of straight lines, and identifies a point at which the straight lines cross one another as the vanishing point 20a.

The night-time determination unit 151 determines whether the average brightness in the region 20b is equal to or more than a predetermined brightness. The night-time determination unit 151 also determines whether the average brightnesses in image data temporally preceding and following the image data 20 are equal to or less than the predetermined brightness. Based on the principle of majority rule, the night-time determination unit 151 determines that the image data 20 has been taken in the night-time when the number of image data with the average brightness in the region 20b lower than the predetermined brightness is larger than the number of image data with the average brightness in the region 20b higher than the predetermined brightness. The night-time determination unit 151 also determines whether image data preceding and following by several minutes the image data 20 have been taken in the night-time.

The night-time determination unit 151 may make determination on night-time image data using the dates and times in the event data recorder information 141. For example, the night-time determination unit 151 determines image data taken at 19 o'clock and later as image data shot in the night-time. The beginning of the night-time may be set as appropriate by the administrator.

The night-time determination unit 151 may extract from the process frames shot in the night-time, process frames describing that the vehicle is sharply decelerated, and output the same to the detection unit 152. For example, the night-time determination unit 151 extracts from the process frames describing the deceleration, process frames with a change in the speed of the process frames equal to or larger than a predetermined value between before and after the deceleration.

The detection unit 152 is a processing unit that detects a high-brightness region from each of the process frames. The detection unit 152 registers in the candidate list information 142 information of process frames in which the ratio of the high-brightness region to a preset detection region is equal to or larger than a predetermined ratio.

FIG. 5 is a diagram (1) for describing a process executed by the detection unit. As illustrated in FIG. 5, the detection unit 152 sets a detection region 21a in a process frame 21. The detection region 21a is a predetermined region including the lane in which the vehicle is running.

For example, the detection region 21a is a triangular region with a vanishing point 22a as a vertex. The bottom side of the detection region 21a is positioned above a bonnet 22b of the vehicle. For example, the vanishing point 22a is positioned according to a vanishing point calculated in advance during straight running of the vehicle. The vanishing point may be determined in the same manner as described above in relation to the night-time determination unit 151. The position of the bonnet 22b may be preset or identified by a predetermined image processing.

The detection unit 152 detects a high-brightness region 21b with a brightness higher than a predetermined brightness in the detection region 21a. Then, the detection unit 152 calculates the ratio of the area of the high-brightness region 21b to the area of the detection region 21a. When the calculated ratio is equal to or more than a predetermined ratio, the detection unit 152 registers the information of the process frame 21 in the candidate list information 142. The predetermined ratio is preset as appropriate by the administrator.

In contrast, when the ratio of the area of the high-brightness region 21b to the area of the detection region 21a is lower than the predetermined ratio, the detection unit 152 does not register the information of the corresponding process frame 21 in the candidate list information 142.

The detection unit 152 performs the foregoing process on all of the process frames 21 acquired from the night-time determination unit 151, and then generates a consolidated candidate based on the process frames registered in the candidate list information 142. For example, the detection unit 152 compares coordinates of the high-brightness region 21b in the process frames with consecutive frame numbers in the candidate list information 142, and generates the set of process frames with the overlapping coordinates as a consolidated candidate. The detection unit 152 then outputs the information of the consolidated candidate to the determination unit 153.

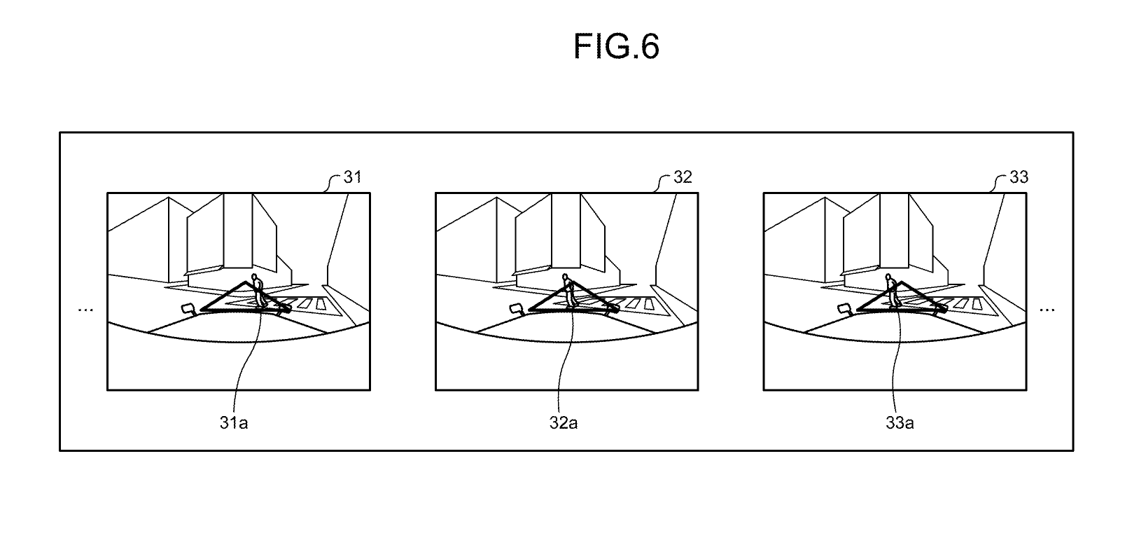

FIG. 6 is a diagram (2) for describing a process executed by the detection unit. Process frames 31, 32, and 33 illustrated in FIG. 6 are registered with consecutive frame numbers in the candidate list information 142. The detection unit 152 compares the coordinates of a high-brightness region 31a in the process frame 31 with the coordinates of a high-brightness region 32a in the process frame 32. The detection unit 152 also compares the coordinates of the high-brightness region 32a in the process frame 32 with the coordinates of a high-brightness region 33a in the process frame 33. There is an overlap between the coordinates of the high-brightness region 31a and the coordinates of the high-brightness region 32a and an overlap between the coordinates of the high-brightness region 32a and the coordinates of the high-brightness region 33a. In this case, the detection unit 152 determines the set of the process frames 31, 32, and 33 as a consolidated candidate.

The determination unit 153 determines whether or not the high-brightness region is a subject to be detected, in a switchable manner depending on whether the process frames included in the consolidated candidate have been taken during curve running or straight running. The subject to be detected is equivalent to a traverser, a bicycle, or the like, for example.

Descriptions will be given as to the process executed by the determination unit 153 for determining whether the process frames included in the consolidated candidate have been taken during curve running or straight running. The determination unit 153 uses the frame numbers of the process frames as keys to acquire positional information of the process frames from the event data recorder information 141, and then determines whether the vehicle was going round a curve based on the positional information. For example, the determination unit 153 compares the positional information of the process frames with map information. When detecting from the comparison that the vehicle was changed in moving direction at an intersection or the like or the vehicle was changed to another lane different in direction from the previous lane, the determination unit 153 determines that the vehicle was going round a curve during the time of the change.

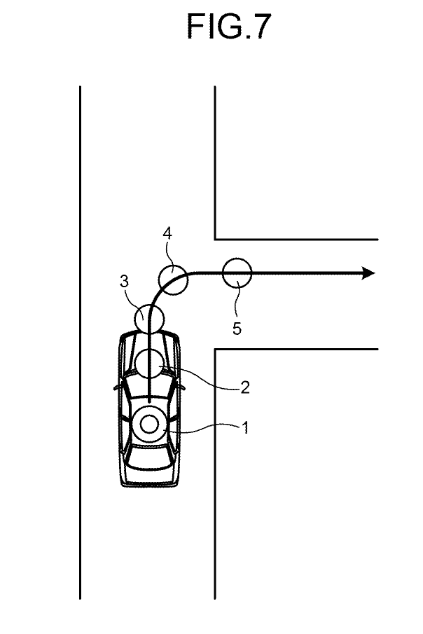

FIG. 7 is a diagram for describing one example of a process executed by the determination unit. For example, as illustrated in FIG. 7, the positions of the process frames change from 1 to 5. In this case, the determination unit 153 determines that the process frames corresponding to the positions 1 to 5 have been taken during curve running of the vehicle.

When the event data recorder information 141 includes blinker information, the determination unit 153 uses the blinker information to determine whether the process frames have been taken during curve running. The determination unit 153 determines the process frames describing illumination of the right blinker or the left blinker, as having been taken during curve running.

In situations other than the foregoing one, the determination unit 153 determines the process frames in the consolidated candidate have been taken during straight running. The determination unit 153 may compare the positional information of the process frames with map information, and determine the process frames describing that the vehicle was running in one and the same lane, as having been taken during straight running.

Next, descriptions will be given as to a process executed by the determination unit 153 for detecting a subject to be detected from the process frames taken during curve running. The determination unit 153 calculates the distance between the camera and the high-brightness region in each of the process frames. When the distance changes at a constant rate, the determination unit 153 determines that the high-brightness region as a stationary object. Meanwhile, when the distance between the camera and the high-brightness region does not change at a constant ratio, the determination unit 153 determines the high-brightness region as a subject to be detected.

The determination unit 153 calculates the differences in distance between the camera and the high-brightness region in the preceding and following process frames. For example, when a process frame N has a distance Na between the camera and the high-brightness region and a process frame N+1 has a distance Nb between the camera and the high-brightness region, the determination unit 153 calculates the difference Na−Nb. When the number of the differences with the value of the difference Na−Nb equal to or more than a threshold value is smaller than a predetermined number, the determination unit 153 determines that the distance changes at a constant rate.

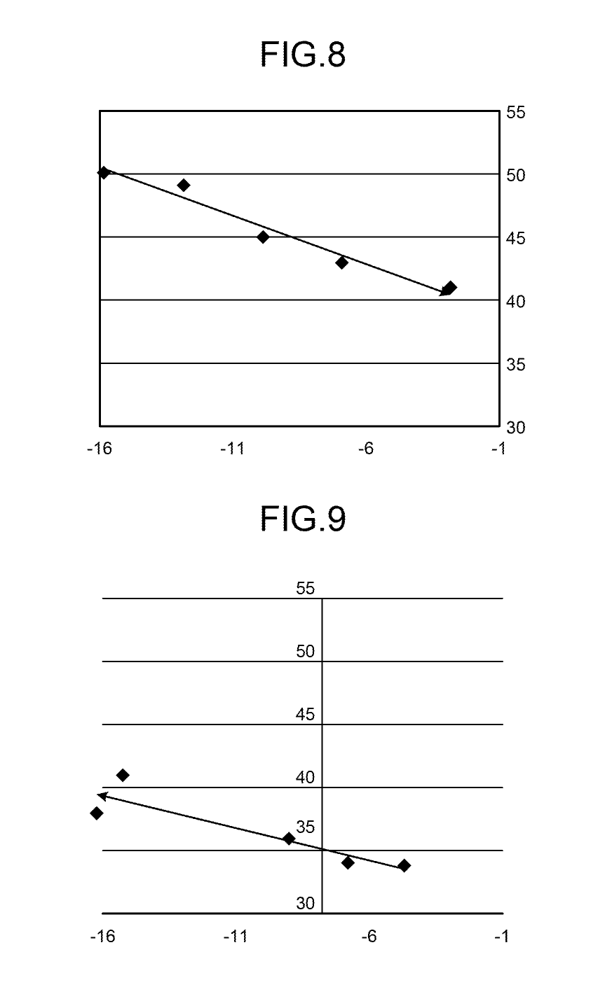

FIG. 8 is a diagram illustrating a relationship in distance between the camera and the high-brightness region with changes in the distance at a constant rate. The vertical axis in FIG. 8 is parallel to the moving direction of the vehicle. The lateral axis in FIG. 8 is perpendicular to the moving direction of the vehicle. When the high-brightness region is a stationary object such as an automatic vending machine, the driver will drive the vehicle at a constant speed without caring about the stationary object, and thus the distance changes at a constant rate.

Meanwhile, when the number of differences with the values equal to or more than the threshold value is equal to or larger than the predetermined number, the determination unit 153 determines that the distance does not change at a constant ratio.

FIG. 9 is a diagram illustrating a relationship in distance between the camera and the high-brightness region without changes in the distance at a constant rate. The vertical axis in FIG. 9 is parallel to the moving direction of the vehicle. The lateral axis in FIG. 9 is perpendicular to the moving direction of the vehicle. When the high-brightness region is a subject to be detected such as a traverser, the vehicle and the traverser move to be distant from each other, and thus the distance does not change at a constant rate.

The determination unit 153 may further use the change in speed of the vehicle to detect a subject to be detected. The determination unit 153 detects a subject to be detected from the process frames taken during curve running, and then refers to the event data recorder information 141 to determine the change in speed of the vehicle at the time of taking the process frames. When the speed of the vehicle is decreased and becomes lower than a predetermined speed, the determination unit 153 concludes that the detected subject is surely a subject to be detected.

Next, descriptions will be given as to a process executed by the determination unit 153 for detecting a subject to be detected from the process frame taken during straight running. In this case, the determination unit 153 determines the high-brightness region in the process frame included in the consolidated candidate, as a subject to be detected.

The determination unit 153 outputs the frame numbers of the process frames including the subject to be detected. For example, the determination unit 153 may output the frame numbers to the display unit 130 or may inform the same to another device via the communication unit 110.

Next, descriptions will be given as to one example of a process executed by the determination unit 153 for calculating the distance between the high-brightness region in the process frames and the camera in the event data recorder. Regardless of the following description, the determination unit 153 may identify the distance between the high-brightness region and the camera using a well-known conversion table for making conversion between the coordinates on the process frames and the distance.

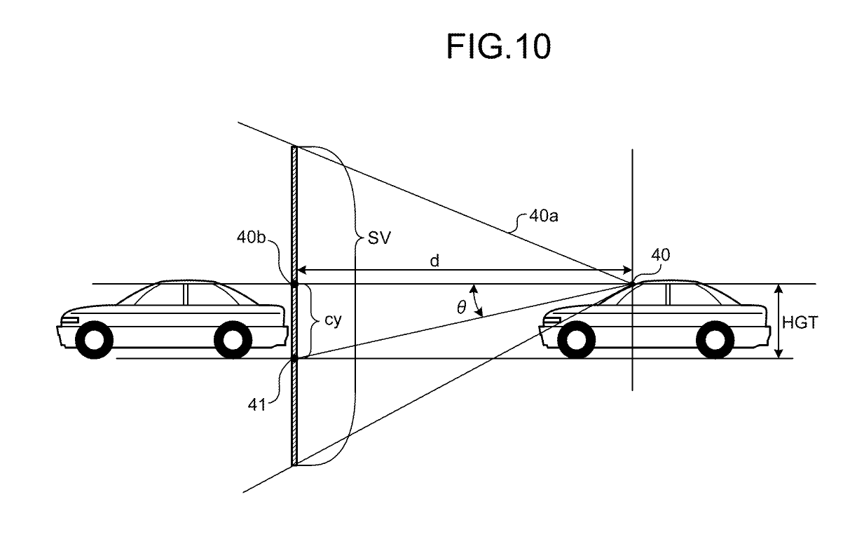

FIG. 10 is a diagram for describing a process for calculating the distance between the high-brightness region and the camera. First, the determination unit 153 acquires the camera parameters 143. The camera parameters 143 include a horizontal angle of view CH (radian) of a camera 40, a vertical angle of view CV (radian) of the camera 40, horizontal resolution SH (pixel) of the process frames, vertical resolution SV (pixel) of the process frames, and installation height HGT (m) of the camera 40.

In FIG. 10, reference numeral 40a represents a camera view, 40b represents the position of a vanishing point, and 41 corresponds to a detection position where a subject to be detected is detected on a projection plane SV at a distance d from the camera 40. In addition, in FIG. 10, symbol θ denotes an angle formed by a straight line linking the camera 40 and the vanishing point 40b and a straight line linking the camera 40 and the detection point 41, and symbol cy denotes a vertical distance between the vanishing point 40b and the detection point 41.

When the following equation (1) holds, θ can be represented by the following equation (2). In addition, with the use of θ, the distance d can be represented by the following equation (3).

cy/SV=θ/CV (1)

θ=CV×cy/SV (2)

d=HGT/tan(θ) (3)

More specifically, the equation (2) can be represented by the following equation (4). In the equation (4), VanY[pixel] denotes y coordinate of a vanishing point on the process frame, y[pixel] denotes y coordinate of a subject to be detected on the process frame, and ABS denotes an absolute value.

θ=CV[rad]×ABS(VanY[pixel]−y[pixel])/SV[pixel] (4)

In addition, the distance along x axis can be calculated by the following equation (5) from the distance between the high-brightness region and the camera. The distance along y axis takes the value of d determined by the equation (3).

Distance along x axis=d×tan(CH[rad]/2)×2 (5)

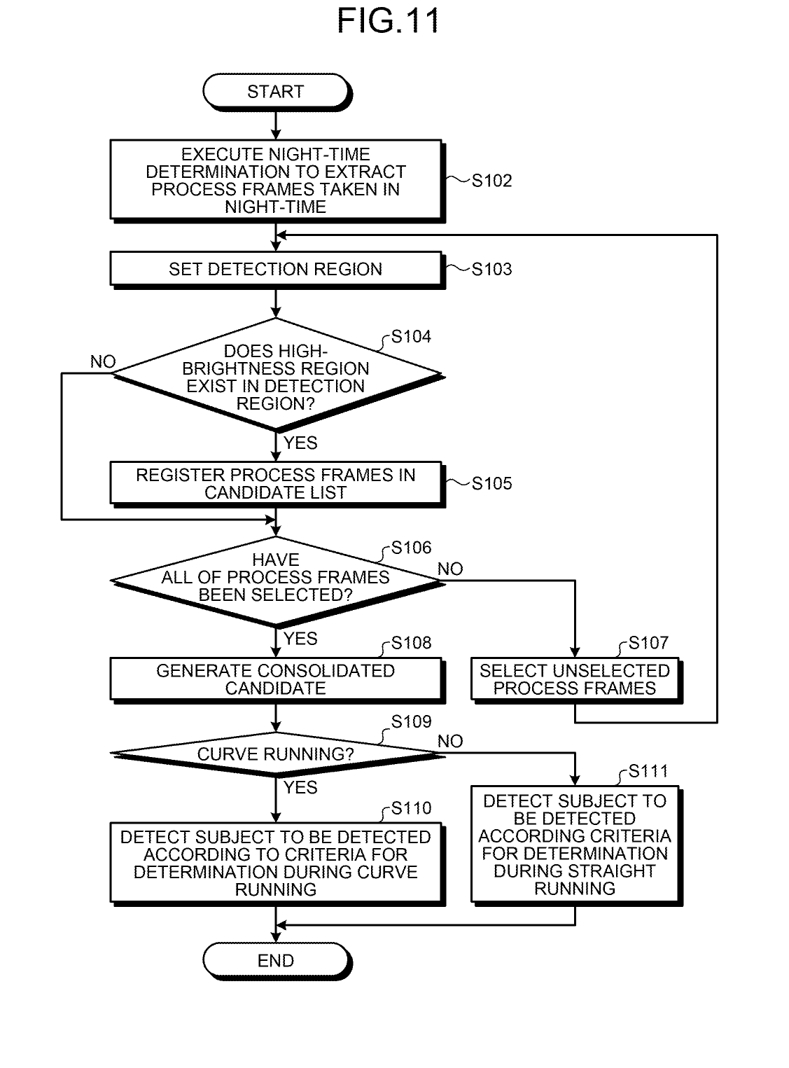

Next, descriptions will be given as to a process executed by the image processing apparatus 100 according to the second embodiment. FIG. 11 is a flowchart of the process executed by the image processing apparatus according to the second embodiment. For example, the image processing apparatus 100 executes the process in the flowchart of FIG. 11 upon receipt of an instruction for execution of the process. The image processing apparatus 100 may receive the instruction for execution of the process from the input unit 120 or another device via the communication unit 110.

As represented in FIG. 11, the image processing apparatus 100 performs a night-time determination to extract process frames taken in the night-time (step S102). The image processing apparatus 100 sets a detection region (step S103) and determines whether any high-brightness region exists in the detection region (step S104).

When no high-brightness region exists in the detection region (step S104: No), the image processing apparatus 100 moves to step S106. Meanwhile, when a high-brightness region exists in the detection region (step S104: Yes), the image processing apparatus 100 registers the process frames in the candidate list information 142 (step S105).

The image processing apparatus 100 determines whether all of the process frames are selected (step S106). When all of the process frames are not yet selected (step S106: No), the image processing apparatus 100 selects unselected process frames (step S107) and moves to step S103.

Meanwhile, when all of the process frames are selected (step S106: Yes), the image processing apparatus 100 generates a consolidated candidate (step S108). The image processing apparatus 100 determines whether the process frames in the consolidated candidate have been taken during curve running (step S109).

When the process frames have been taken during curve running (step S109: Yes), the image processing apparatus 100 detects a subject to be detected according to a criteria for determination during curve running (step S110). Meanwhile, when the process frames have been taken during straight running (step S109: No), the image processing apparatus 100 detects a subject to be detected according to a criteria for determination during straight running (step S111).

Next, descriptions will be given as to operations of the image processing apparatus 100 according to the embodiment. The image processing apparatus 100 determines the process frames taken in the night-time. The image processing apparatus 100 determines whether a high-brightness region is a subject to be detected, in a switchable manner depending on whether the process frames have been taken during curve running or straight running. For example, if the lane in which the vehicle is running is set as a detection region, a stationary object in the detection region is wrongly detected as a high-brightness region during curve running. Meanwhile, when the vehicle is running in straight, no stationary object is detected in the detection region. Accordingly, by determining whether or not the high-brightness region is a subject to be detected in a switchable manner depending on whether the vehicle is curve-running or straight-running, it is possible to make determinations according to the both situations and correctly detect a subject to be detected.

When the process frames constitute moving image data taken during curve running, the image processing apparatus 100 determines whether to set the high-brightness region as a subject to be detected, based on changes in the speed of the vehicle or changes in the distance between the camera and the high-brightness region after the detection of the high-brightness region. Accordingly, it is possible to correctly determine whether the high-brightness region included in the detection region during curve running is a subject to be detected or a stationary object. For example, when the high-brightness region is a traverser or the like, the driver will take notice of him/her and rapidly slow down the vehicle. In contrast, when the high-brightness region is a stationary object, the driver will drive the vehicle at a constant speed without caring about it. Otherwise, when the high-brightness region is a pedestrian, the pedestrian and the vehicle move to avoid a collision with each other, and thus it is conceived that there arise variations in changes of the distance between the high-brightness region and the camera.

The image processing apparatus 100 also uses the process frames describing the deceleration to detect a subject to be detected. For example, when the cause of deceleration has been eliminated, the driver will speed up the vehicle and thus, at that time, there is no subject to be detected as a cause of a near-accident seen in the image. Accordingly, by detecting a subject to be detected with the use of the process frames describing deceleration of the vehicle, it is possible to eliminate the need for performing an unnecessary process.

In addition, the image processing apparatus 100 detects the high-brightness region from a predetermined area including the lane in which the vehicle is running. Since a traverser is likely to be in the lane in which the vehicle is running, by setting the area including the lane of the vehicle as a detection target, it is possible to reduce the amount of computation as compared to the case of detecting a subject to be detected from the entire image.

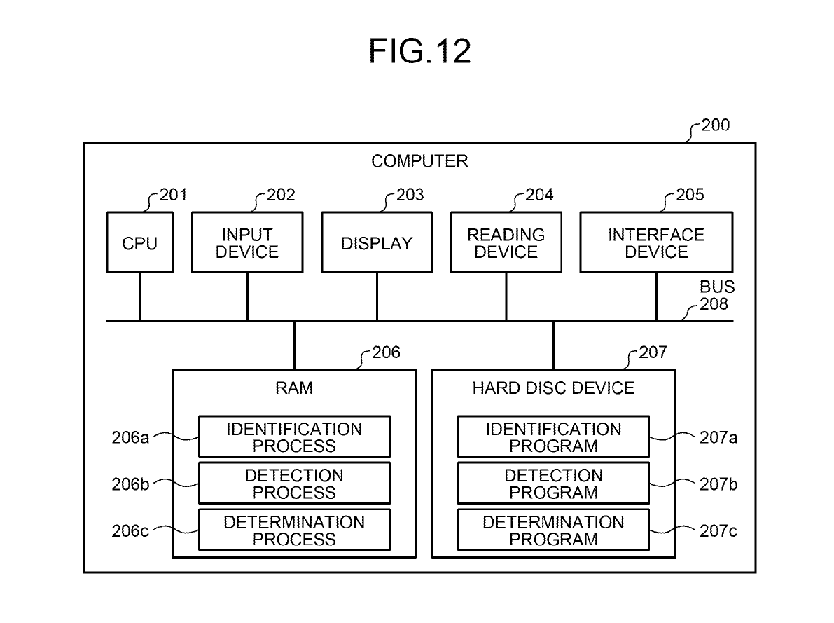

Next, descriptions will be given as to one example of a computer to execute an image processing program for realizing the same functionality as that of the image processing apparatus described above in relation to the foregoing embodiment. FIG. 12 is a diagram illustrating one example of a computer to execute an image processing program.

As illustrated in FIG. 12, a computer 200 has a CPU 201 that executes various computational processes, an input device 202 that accepts input of data from a user, and a display 203. The computer 200 also has a reading device 204 that reads programs and others from recording media and an interface device 205 that exchanges data with other computers via a network. The computer 200 further has a RAM 206 that temporarily stores various kinds of information and a hard disc device 207. The devices 201 to 207 are connected to a bus 208.

The hard disc device 207 has an identification program 207a, a detection program 207b, and a determination program 207c. For example, the CPU 201 reads the programs 207a to 207c and expands them in the RAM 206.

The identification program 207a serves as an identification process 206a. The detection program 207b serves as a detection process 206b. The determination program 207c serves as a determination process 206c.

For example, the identification process 206a is equivalent to the identification unit 11, the night-time determination unit 151, or the like. The detection process 206b is equivalent to the detection unit 12 or 152, or the like. The determination process 206c is equivalent to the determination unit 13 or 153.

The programs 207a to 207c are not necessarily stored in the hard disc device 207 from the beginning. For example, the programs are stored in portable physical media to be inserted in the computer 200, such as flexible disc (FD), a CD-ROM, a DVD disc, an optical magnetic disc, and an IC card. Then, the computer 200 reads the programs 207a to 207c from these media and executes the same.

According to one embodiment of the present invention, it is possible to provide an advantage in that it is possible to correctly detect a subject to be detected.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing apparatus, comprising a processor configured to execute a process comprising:
identifying moving image data taken by a camera in the night-time;
detecting a region of brightness from frames of the moving image data; and
determining whether the region is a subject to be detected, in a different manner depending on whether the moving image data has been taken during curve running or straight running.

2. The image processing apparatus according to claim 1, wherein, when the moving image data have been taken during curve running, the determining determines whether to set the region as a subject to be detected, based on changes in the speed of a moving object or changes in the distance between the camera and the region after the detection of the region.

3. The image processing apparatus according to claim 2, wherein
the moving image data is associated with speed data, and
the identifying identifies frames describing deceleration out of the frames included in the moving image data.

4. The image processing apparatus according to claim 3, wherein the detecting detects the region from a predetermined area including a lane in which the moving object is running.

5. An image processing method executed by a computer, the method comprising:
identifying moving image data taken by a camera in the night-time;
detecting a high-brightness region from frames of the identified moving image data; and
determining whether or not the high-brightness region is a subject to be detected, in a switchable manner depending on whether the moving image data has been taken during curve running or straight running.

6. A computer-readable recording medium having stored therein an image processing program that causes a computer to execute a process including:
identifying moving image data taken by a camera in the night-time;
detecting a region of brightness from frames of the moving image data; and
determining whether the region is a subject to be detected, in a different manner depending on whether the moving image data has been taken during curve running or straight running.
